(19) United States
(12) Patent Application Publication
(10) Pub. No.: US 2024/0021354 A1
(43) Pub. Date: Jan. 18, 2024

(54) MOLD CORE, REACTOR, AND MOLD CORE MANUFACTURING METHOD

(71) Applicant: Tamura Corporation, Tokyo (JP)

(72) Inventors: Masato Kaneko, Saitama (JP); Shigeo UMAHASHI, Escondido, CA (US); Kotaro SUZUKI, Saitama (JP)

(21) Appl. No.: 18/220,081

(22) Filed: Jul. 10, 2023

(30) Foreign Application Priority Data
Jul. 14, 2022 (JP) 2022-113314

(51) Int. Cl. H01F 27/255; H01F 41/02; H01F 27/02

(52) U.S. Cl. CPC H01F 27/255; H01F 41/0246; H01F 27/022; H01F 1/14791

(57) ABSTRACT

Provided is a mold core, a reactor having the mold core, and a manufacturing method of the mold core in which the leg portion connecting surfaces of the yoke portions are aligned at the same height and gaps are prevented from forming between the end surfaces of the leg portions and the leg portion connecting surfaces. The mold core 2 of the reactor 1 is made of a dust core and includes the yoke cores 41 for connecting a plurality of leg portions 32, and the yoke resins 42 for molding the yoke cores 41 by insert molding. The yoke cores 41 are divided into a plurality of core blocks 5 connected in a row without gaps, and the core blocks 5 include leg-portion-side blocks 61 that are connected to the leg portions 32 one-to-one.

### CROSS-REFERENCE TO RELATED APPLICATION

This application is based upon and claims the benefit of priority from Japan Patent Application No. 2022-113314, filed on Jul. 14, 2022, the entire contents of which are incorporated herein by reference.

### FIELD OF INVENTION

The present application relates to a mold core formed by molding a core inserted into a coil with resin, a reactor having the mold core, and the mold core manufacturing method.

### BACKGROUND

A reactor is an electromagnetic component that converts electric energy into magnetic energy for accumulation and release. Reactors are used in a wide variety of applications. Representative examples of reactors include step-up reactors, series reactors, parallel reactors, current-limiting reactors, starting reactors, shunt reactors, neutral point reactors, and arc extinguishing reactors.

Step-up reactors are incorporated into booster circuits for vehicles such as hybrid vehicles and electric vehicles. Series reactors are connected in series with motor circuits to limit current during a short circuit. Parallel reactors stabilize current sharing between parallel circuits. Current-limiting reactors limit current during a short circuit. Starting reactors are connected in series with motor circuits protecting machines to limit starting current. Shunt reactors are connected in parallel to transmission lines to compensate for phase-advancing reactive power and suppress abnormal voltage. Neutral point reactors are connected between neutral point and ground and used to limit the ground fault current flowing in the event of a ground fault in a power system. Arc extinguishing reactors automatically extinguishes an arc occurring when a single-line ground fault occurs in a three-phase power system.

The reactor mainly consists of a coil and a core. The core is formed by connecting two or more leg portions and two or more yoke portions in a closed loop. The coil is attached to at least one leg portion. The yoke portions are arranged separately at both ends of the leg portions extending in parallel, extend orthogonally to the leg portions, and connect the leg portions. In such reactor, the coil generates magnetic flux according to the number of turns by energization. The core forms a closed magnetic circuit through which the magnetic flux generated by the coil passes according to a magnetic permeability higher than that of a vacuum. For this reason, dust cores made by compacting soft magnetic powder are widely used for the core.

The soft magnetic powder is compacted according to a shape of each leg portions and yoke portions, and then annealed. A closed annular core in which the leg portions and yoke portions are connected is manufactured by bonding the finished leg portions and yoke portions with an adhesive, or coating each of them with resin and screwing them together with bolts or the like.

### SUMMARY OF INVENTION

### Problems to be Solved by Invention

When a pressure-molded body in which soft magnetic powder is compacted is annealed, there is a possibility that shrinkage or warpage may occur in various parts of the dust core. The shrinkage and warpage of the dust core are related to a density distribution of the soft magnetic powder, and the shrinkage and warpage vary in various parts of the soft magnetic powder. As the size of the dust core increases, the variation in the shrinkage and warpage occurring in various parts of the dust core increases.

One surface of the yoke portions is lined with leg portion connecting surfaces with which the end surfaces of the leg portions come into contact. When the yoke portions become large, the unevenness that occurs on the one surface where the leg portion connecting surfaces are lined becomes noticeable due to the shrinkage and warpage by the annealing. In that case, when the leg portions are butted against the yoke portions, gaps are generated between the end face of one of the leg portions and the leg portion connecting surfaces. The gap becomes magnetic resistance. Therefore, when the gap different from design is generated in the closed magnetic circuit of the core, the magnetic resistance increases unlike the design, causing inconvenience such as deterioration of a DC superimposition characteristic of an inductance.

The present disclosure is achieved to address the above-described problem, and the objective is to provide a mold core, a reactor having the mold core, and a manufacturing method of the mold core in which the leg portion connecting surfaces of the yoke portions are aligned at the same height and gaps are prevented from forming between the end surfaces of the leg portions and the leg portion connecting surfaces.

### Means to Solve the Problem

To achieve the above-described objective, a mold core of the present disclosure includes: a yoke core made of a dust core and connecting a plurality of leg portions, yoke resin molding the yoke core by insert molding, in which the yoke cores are divided into a plurality of core blocks connected in a row without gaps, and the core blocks include leg-portion-side blocks that are connected to the leg portions one-to-one.

Each of the leg-portion-side blocks may include a leg portion connecting surface connecting with an end surface of a corresponding leg portion and may be covered with the yoke resin while the leg portion connecting surfaces are positioned so as to be aligned on a same plane.

The yoke resin may include a leg-portion-side opening through which the leg portion connecting surface is exposed and a rear opening located on the opposite side of the leg-portion-side opening.

The core blocks may include a connecting block interposed between the leg-portion-side blocks, the yoke resin may have a gate mark bulging portion that is a resin injection hole mark, and the gate mark bulging portion may be formed in a covering region covering the connecting block.

The yoke core may be divided into three core blocks, and the core blocks may include two leg-portion-side blocks and the connecting block interposed between the leg-portion-side blocks.

The yoke core may be divided into five core blocks, and the core blocks may include three leg-portion-side blocks and two connecting blocks interposed between two of the leg-portion-side blocks.

The yoke core may be divided into five core blocks, and the core blocks may include three leg-portion-side blocks and two connecting blocks interposed between two of the leg-portion-side blocks, and the gate mark bulging portion may be formed in a covering region covering at least one of the connecting block.

The leg portion may be further included.

The yoke resin may include a fastening portion that is fastened to the leg portion by tightening fastener, the fastening portion may be formed in the covering area that covers the leg-portion-side blocks.

Moreover, in order to achieve the above objective, the reactor according to the present embodiments includes the mold core and a coil attached to at least one leg portions.

Further, in order to achieve the above objective, a method for manufacturing a mold core according to the present embodiments includes: a dust core forming step forming a dust core serving as a yoke core for connecting a plurality of leg portions; a mold setting step setting the yoke core in a mold by installing the yoke core in a fixed mold of the mold and pressing the yoke core against the fixed mold with a slide mold of the mold; and an injection molding step molding the yoke core with the yoke resin by injecting the resin into the mold, in which the yoke core is divided into a plurality of core blocks connected in a row without gaps, the core blocks includes leg-portion-side blocks that are connected to the leg portions one-on-one, each of the leg-portion-side blocks has a leg portion connecting surface that connects with an end surface of the corresponding leg portion, in the dust core forming step, the core blocks are individually formed by pressure molding and annealing, the fixed mold has support portions that are positioned at a same height and support each of the leg portion connecting surfaces, and in the mold setting step, the core blocks are connected to the leg portions one-on-one arranged side by side in the fixed mold while the leg portion connecting surface of the leg portion side block is placed on each support portion, and the leg portion connecting surfaces are positioned so as to be aligned on a same plane by pressing the leg-portion-side blocks against each of the support portions with the slide mold.

In the dust core forming step, the dust core may be formed for each core block.

The core blocks may include the connecting block interposed between the leg-portion-side blocks, and the yoke resin is injected toward the connecting block in the injection molding step.

A connecting step adhering the leg portion to the leg portion connecting surface with an adhesive may be included.

In the injection molding step, the resin is formed with a fastening portion that is fastened to the leg portion by tightening a fastener, and a connecting step of connecting the leg portion to the yoke core molded with the resin through the fastening portion may be further included.

### Effect of Invention

According to the present application, each leg portion connecting surface of the yoke core is easily aligned on a same plane, and a gap is less likely to occur between an end surface of the leg portion and the leg portion connecting surface.

### BRIEF DESCRIPTION OF DRAWINGS

FIG. 1 is a perspective view showing a mold core of a first embodiment.

FIG. 2 is an exploded view of the mold core.

FIG. 3 is a perspective view of a yoke core.

FIG. 4 is an exploded view of the yoke core.

FIG. 5 is a flow chart showing a dust core forming step.

FIG. 6 is a schematic diagram showing alignment of leg-portion-side blocks.

FIG. 7 is a schematic diagram showing positioning of leg-portion-side blocks.

FIG. 8 is a perspective view of a yoke resin viewed from one side.

FIG. 9 is a perspective view of a yoke resin viewed from the other side.

FIG. 10 is a perspective view showing a mold core of a second embodiment.

FIG. 11 is a perspective view showing a mold core of a third embodiment.

### EMBODIMENTS

Hereinafter, a reactor of each embodiment will be described with reference to the drawings. In each drawing, for ease of understanding, there are cases where thickness, dimensions, positional relationships, ratios, shapes, etc. may be emphasized, and the present disclosure is not limited thereto.

### First Embodiment

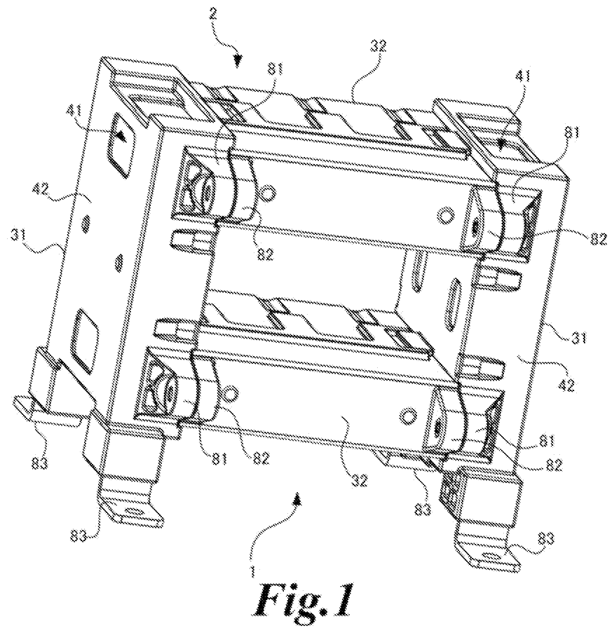

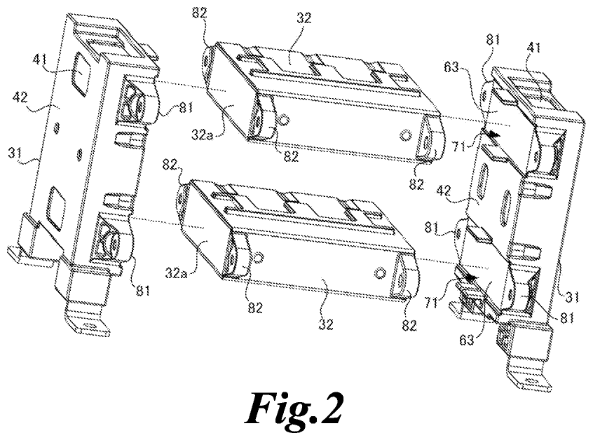

A reactor according to the first embodiment of the present application will be described with reference to the figures. FIG. 1 is the perspective view showing the main configuration of a reactor 1 of this embodiment, and FIG. 2 is the exploded view of a mold core 2. In FIGS. 1 and 2, coils are omitted for convenience of explanation.

As shown in FIGS. 1 and 2, this reactor 1 includes the mold core 2. The mold core 2 has a closed ring shape or a plurality of closed ring shapes connected each other by sharing edges. The reactor 1 also includes a coil (not shown) attached to the mold core 2. The coil is a winding in which a conductive wire is helically wound along a winding axis while shifting its winding position for each turn.

The coil is an inductor that generates a magnetic flux according to the number of turns when energized from a circuit in which the reactor 1 is incorporated, and introduces inductive reactance into the circuit. The mold core 2 is a dust core coated with mold resin by insert molding. The dust core is formed by compacting and annealing magnetic powder. That is, the mold core is a closed magnetic circuit through which the magnetic flux generated by the coil passes according to a magnetic permeability higher than that of a vacuum.

Therefore, the reactor 1 becomes an electromagnetic component that converts electric energy into magnetic energy for accumulation and release. Note that the molding resin electrically insulates the coil from the dust core, protects the dust core from mechanical wear, and covers the dust core in order to maintain a shape of the mold core 2.

The mold core 2 includes a plurality of leg portions 32 and a pair of yoke portions 31. For example, the mold core 2 has two leg portions 32 and a pair of yoke portions 31, and the leg portions 32 and the yoke portions 31 are alternately arranged to form one closed ring shape. The plurality of leg portions 32 have the same length and are arranged in parallel on the same plane with their ends aligned. The coil may be attached to at least one leg portion 32 or may be attached to all the leg portions 32.

The yoke portions 31 connect the leg portions 32. The yoke portions 31 are arranged separately at both ends of the leg portions 32. The yoke portions 31 extend orthogonally to the leg portions 32 and connect the plurality of leg portions 32. The length of the yoke portions 31 are the same as a distance between the outer peripheral surfaces of the outer leg portions 32, and both ends of the outer leg portions 32 are connected to both ends of the yoke portion 31.

The yoke portion 31 includes yoke cores 41 that are dust core and yoke resins 42 that are mold resins covering the yoke core 41. The yoke cores 41 include leg portion connecting surfaces 63 at positions facing the leg portion end surfaces 32a of the leg portions 32. The leg portion connecting surface 63 is a region adhered to the leg portion end surfaces 32a with an adhesive. The yoke cores 41 and the leg portions 32 are connected with the leg portion connecting surfaces 63 and the leg portion end surfaces 32a facing each other.

The leg portion connecting surfaces 63 has the same shape as the leg portion end surface 32a or has a width that includes the entire leg portion end surface 32a. Leg-portion-side openings 71 are formed in the yoke resins 42. The leg-portion-side openings 71 completely expose the leg portion connecting surfaces 63. For example, when the mold core 2 has two leg portions 32, each yoke portion 31 is provided with two leg portion connecting surfaces 63 that are exposed through the leg-portion-side openings 71.

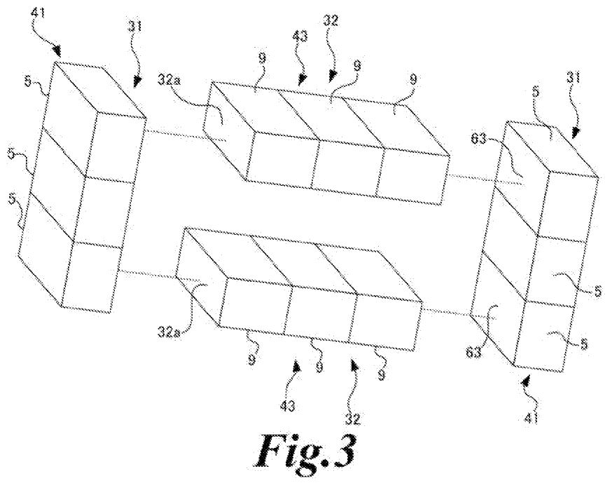

FIG. 3 is the perspective view of yoke cores 41 included in the yoke portions 31. The yoke cores 41 are divided into a plurality of the core blocks 5. The plurality of core blocks 5 is arranged in a row to form yoke cores 41. The leg portions 32 are formed by insert-molding the dust cores with resin, leg cores 43, which is dust cores constitute the leg portion 32, are also formed by aligning a plurality of core blocks 9 in a row.

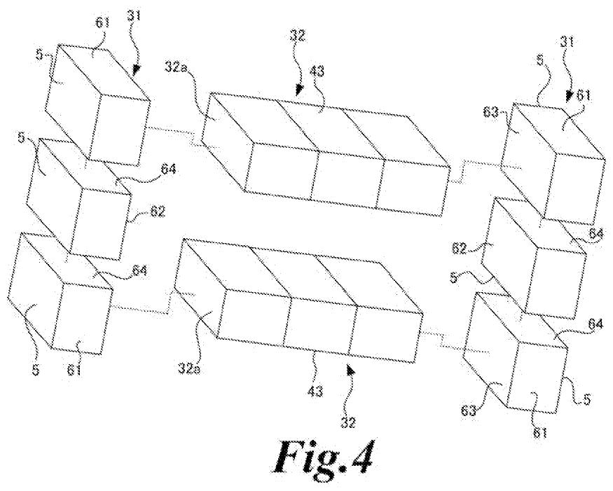

FIG. 4 is an exploded view of the yoke core 41. The core blocks 5 have inter-block connecting surfaces 64 on surfaces facing the adjacent core blocks 5. The core blocks 5 are connected in a gapless manner with their inter-block connecting surfaces 64 facing each other without a gap. That is, there are no gaps between the core blocks 5 and no adhesive layer is interposed between the core blocks 5. The core blocks 5 are fixed by insert molding with the yoke resins 42 by directly abutting the inter-block connecting surfaces 64 without applying the adhesive.

In the yoke cores 41, the core blocks 5 are roughly divided into a leg-portion-side blocks 61 and connecting blocks 62. The leg-portion-side blocks 61 are the core blocks 5 that are connected to the leg portions 32 one-to-one. The connecting blocks 62 are the core blocks 5 interposed between the leg-portion-side blocks 61. The leg portion connecting surfaces 63 are located on the leg-portion-side blocks 61 which face the leg portion end surfaces 32a of the leg portions 32 by their entire surface. In other words, the core blocks 5 are divided so that one leg portion connecting surface 63 is included in one leg side block 61 and the leg portion connecting surface 63 does not straddle the adjacent connecting block 62.

For example, when the mold core 2 has two leg portions 32, each yoke portion 31 is divided into one connecting block 62 located in the center and two leg-portion-side blocks 61 connected to both sides of the connecting block 62 and connected to the corresponding leg portions 32.

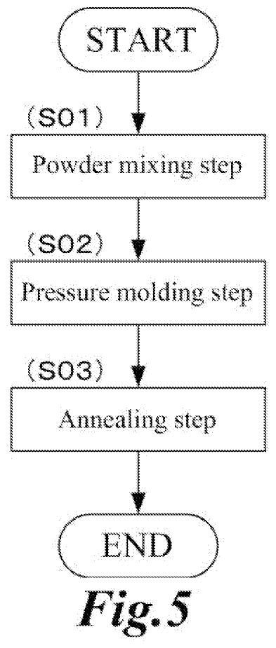

A method of manufacturing each core block 5 of the yoke portions 31 is as follows. FIG. 5 is the flow chart showing the dust core forming step. The dust core is manufactured by undergoing a powder mixing step (step S01) for mixing magnetic powder, a pressure molding step (step S02) for pressure molding the magnetic powder into the core block 5, and an annealing step (step S03) for annealing a molded body after the pressure molding step.

The magnetic powder is soft magnetic powder. The magnetic powder is iron-based and includes, for example, pure iron powder, iron-based permalloy (Fe—Ni alloy), Si-containing iron alloy (Fe—Si alloy), sendust alloy (Fe—Si—Al alloy), or a mixed powder of two or more of these powders. The magnetic powder may be an amorphous alloy or a nanocrystalline alloy powder. The magnetic powder may be a mixed powder of two or more types instead of one type.

This magnetic powder may be produced by a pulverization method or may be produced by an atomizing method. In the pulverization method, the FeSiAl alloy metal block is mechanically pulverized by a jaw crusher, hammer mill, attrition mill, stamp mill, ball mill, or the like. The atomizing method may be a water atomizing method, a gas atomizing method, or a water gas atomizing method.

The magnetic powder may be coated with an insulating resin. The insulating resin may be attached so as to cover an entire surface of the magnetic powder, may be attached so as to cover a part of the surface of the magnetic powder, or both of these aspects may be mixed. In addition, the insulating resin may be attached to each particle of the magnetic powder, may be attached to a surface of aggregates of particles the magnetic powder, or both of these aspects may be mixed. When partially covering the surface of the particles or aggregates, the insulating resin may be dispersed and attached in the form of dots, may be dispersed and attached in the form of blocks, or may be a mixture of these aspects.

Example insulating resins are a silane compound, a silicone resin, or both of these. For example, when the magnetic powder is coated with both the silane compound and the silicone resin, the silane compound and the silicone resin may be separate layers, or a single layer in which each type is mixed. After the insulating resin and the magnetic powder are mixed, they are dried by exposing to a predetermined temperature environment, although not particularly limited.

In the pressure molding step, the magnetic powder with insulation coating is pressure-molded into the shape of the core blocks 5 to form a molded body. The pressure during molding is, for example, 10 to 20 ton/cm², preferably about 12 to 15 ton/cm², approximately. A lubricant may be mixed prior to the pressure molding step.

In the annealing step the molded body after the pressure molding step is heated to remove distortion. The heating environment is an inert atmosphere, a reducing atmosphere, or the atmosphere. Inert atmospheres and reducing atmospheres have a low amount of reactive gas and are atmospheres filled with inert gas or neutral gas. The reactive gas is oxygen, water vapor, carbon gas, or the like. The inert gas is argon, helium, or the like. The gas is nitrogen, ammonia, and the like.

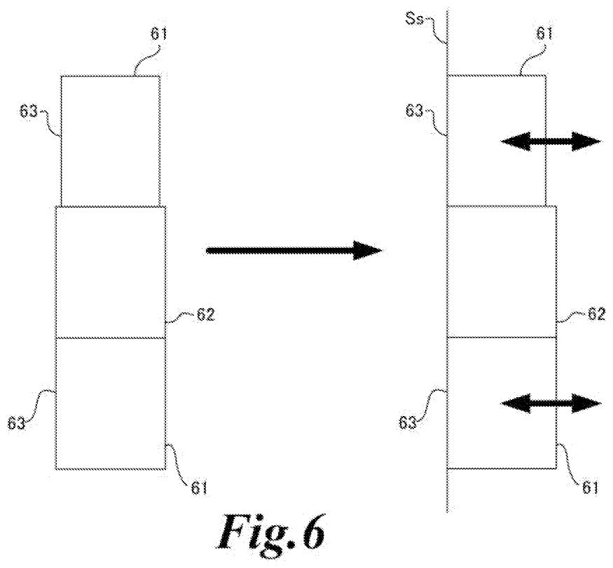

FIG. 6 is the schematic diagram showing alignment of each core block 5 of the yoke portions 31 manufactured in this way. Each leg-portion-side block 61 is independently movable by dividing the yoke cores 41 into the core blocks 5. Each leg-portion-side block 61 is independently adjusted its position and positioned so that all leg-connecting surfaces 63 are aligned with the same reference plane Ss. Therefore, when the leg portions 32 are butted against the yoke portions 31, a possibility that a gap is generated between the leg portion end surface 32a of any of the leg portions 32 and the leg portion connecting surfaces 63 is reduced.

For example, each leg-portion-side block 61 may be positioned through a mold setting step for injection molding the yoke resins 42 covering the yoke cores 41. In the mold setting step, the leg-portion-side block 61 is pressed to be positioned at the required position. According to the positioning by pressing against the mold, the positioned leg-portion-side block 61 can be fixed by the yoke resins 42 at the same time as the resin molding.

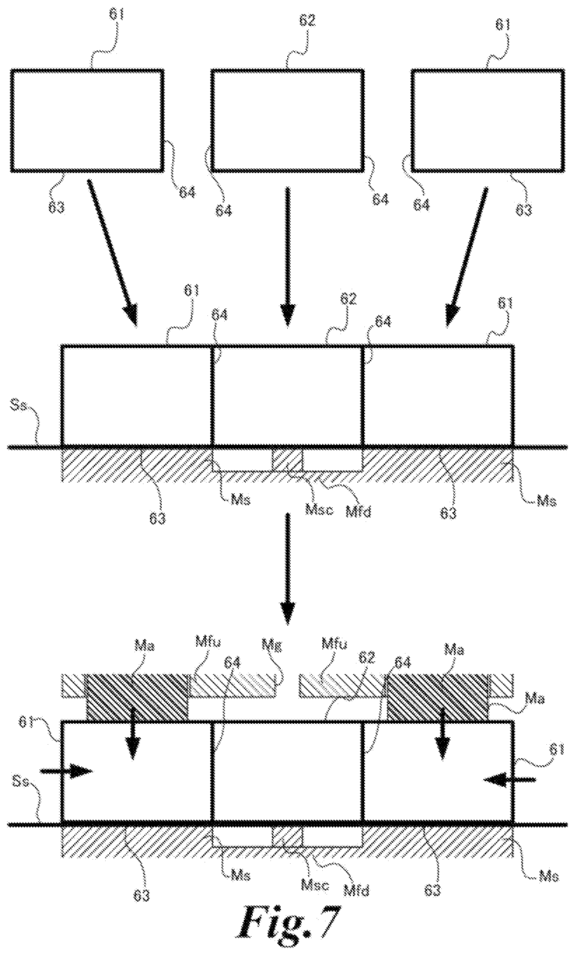

FIG. 7 is the schematic diagram showing positioning of the leg-portion-side blocks 61. As shown in FIG. 7, in the mold setting step, first, the leg-portion-side blocks 61 and the connecting blocks 62 constituting the yoke portions 31 are placed on a fixed mold (lower mold) Mfd. When manufacturing the mold core 2 having two leg portions 32, the inter-block connecting surface 64 of one connecting block 62 are arranged side by side in a row so that the inter-block connecting surfaces 64 of the leg-portion-side blocks 61 on both sides are in contact with each other, in the fixed mold (lower mold) Mfd.

The fixed mold (lower mold) Mfd has the same number of support portions Ms as the leg portions 32. The support portions Ms is a support stand protruding into the mold from the fixed mold (lower mold) Mfd. The support portions Ms extend on a reference plane Ss having a same flatness, the flatness have a same width as the leg portion end faces 32a of the leg portions 32, and are erected at the same intervals. The leg-portions-side blocks 61 are placed on the support portions Ms by matching each leg portion connecting surface 63 of the leg-portion-side blocks 61 one by one. A projecting portion Msc for supporting the connecting block 62 also protrudes from the fixed mold (lower mold) Mfd.

After each core block 5 is arranged side by side in the fixed mold (lower mold) Mfd, the fixed mold (upper mold) Mfu and the slide mold Ma are placed on the opposite side of the fixed mold (lower mold) Mfd. Then, each leg-portion-side block 61 is pressed against the supporting portions Ms of the fixed mold (lower mold) Mfd by the slide mold Ma. As a result, the leg portion connecting surfaces 63 of each leg-portion-side blocks 61 are aligned with the reference plane Ss that is the same plane.

The rows of the core blocks 5 are also pressed by the molds from both sides along the direction in which the rows are arranged and the inter-block connecting surfaces 64 are in close contact with each other, thereby preventing the formation of resin in the yoke cores 41 due to the presence of a gap in the yoke cores 41.

A gate Mg for injecting resin to be the yoke resins 42 is opened in the fixed mold (upper mold) Mfu. The gate Mg avoids the leg-portion-side blocks 61 and opens at a position facing the connecting block 62. After the inside is sealed with the fixed mold (lower mold) Mfd, the fixed mold (upper mold) Mfu, and the slide mold Ma, an injection molding step in which yoke cores 41 are molded with a yoke resins 42 is performed, and resin is injected from this gate Mg to cover the yoke cores 41 with the yoke resins 42.

During resin injection, since the leg-portion-side block 61 is not directly subjected to injection pressure from the gate Mg, this reduces the risk that the leg-portion-side block 61 will be pushed by the injection pressure and that the leg portion connecting surface 63 will deviate from the reference plane Ss. The positions of the leg portion connecting surfaces 63 aligned with the reference plane Ss are maintained by covering the leg-portion-side blocks 61 with the yoke resins 42.

Example materials of the yoke resins 42 are epoxy resin, unsaturated polyester resin, urethane resin, BMC (Bulk Molding Compound), PPS (Polyphenylene Sulfide), PBT (Polybutylene Terephthalate), and compositions thereof, with insulation and heat resistance. Thermally conductive filler may be mixed with the yoke resins 42.

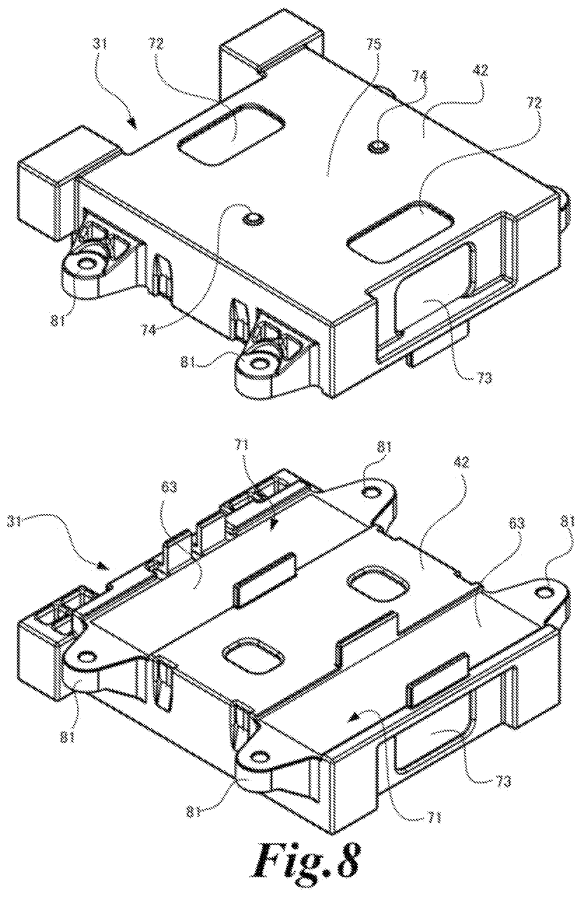

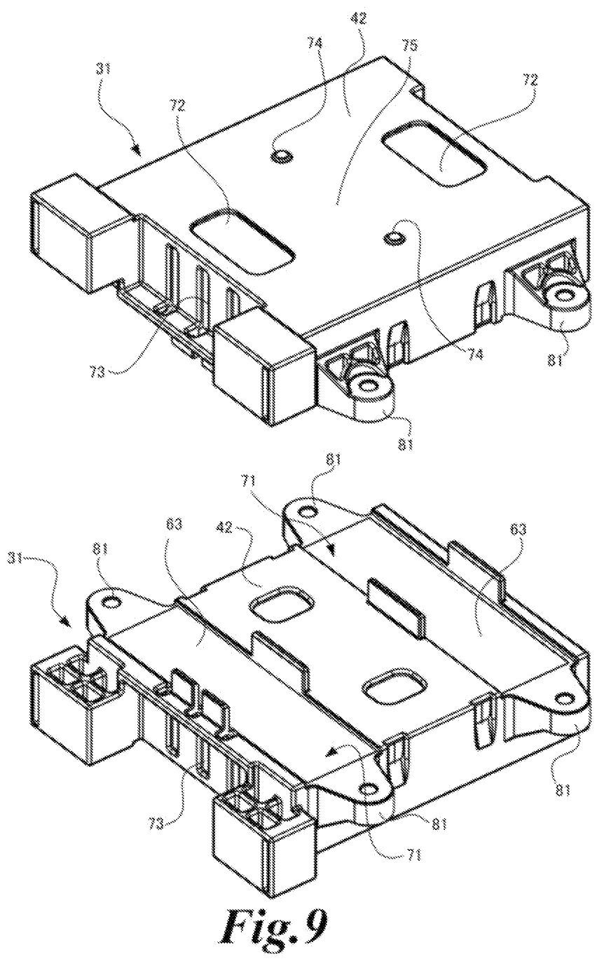

FIG. 8 is the perspective view of the yoke portion 31 having the yoke resin 42 as viewed from one side, and FIG. 9 is the perspective view of the yoke portion 31 having the yoke resin 42 as viewed from the other side. As shown in FIGS. 8 and 9, the yoke cores 41 are coated with yoke resins 42 through an injection molding step. In a connecting block covering area 75 covering the connecting block 62, gate mark bulging portions 74 bulges out from the connecting block covering area 75 and is an injection hole mark of the yoke resins 42.

Leg-portion-side openings 71 are formed in the yoke resins 42 by contact with the support portions Ms, and the entire leg portion connecting surface 63 is exposed from the leg-portion-side openings 71. Rear openings 72 are formed on the opposite side of the leg-portion-side openings 71. The rear openings 72 are a trace formed when the slide molds Ma are brought into contact with the leg portion connecting surfaces 63 to push them against the support portions Ms, and the leg-portion-side blocks 61 are exposed. Heat can be dissipated from these rear openings 72 as well. The rear openings 72 may be filled with resin plates to prevent direct contact between the slide molds Ma and the leg-portion-side blocks 61.

One side perpendicular to the side on which the leg-portion-side openings 71 are formed, and on that side, holding openings 73 formed by holding the core blocks 5 along the row direction with molds are formed, and heat can be dissipated from this holding openings 73 as well. One of the holding openings 73 is formed by being contact with the fixed mold (lower mold) Mfd and has a large rectangular shape, and the other of the holding openings 73 is formed by being contact with the slide mold Ma and has a plurality of L-shaped slits.

Furthermore, fastening portions 81 protrude from the yoke resins 42 so as to put the leg portion connecting surfaces 63 therebetween. The leg portions 32 are also provided with a fastening portion 82 so as to put the leg portion end surface 32a (see FIG. 2). The yoke portions 31 and the leg portions 32 are connected by fastening the fastening portions 81 and 82 using bolts and screws in addition to the bonding between the leg portion connecting surfaces 63 and the leg portion end surfaces 32a. When screwing together with bolts and screws, although a large torque is generated in an adhesive layer between the leg portion connecting surfaces 63 and the leg portion end surface 32a, since the leg portion connecting surfaces 63 are positioned at and in close contact with the reference planes Ss, separation between the yoke portions 31 and the leg portions 32 due to torque is suppressed.

A metal stays 83 through which a bolt can be inserted are also insert-molded in the yoke portions 31 when the yoke resins 42 are formed (see FIG. 1). The reactor 1 can be mounted on the circuit via this stays 83.

### Second Embodiment

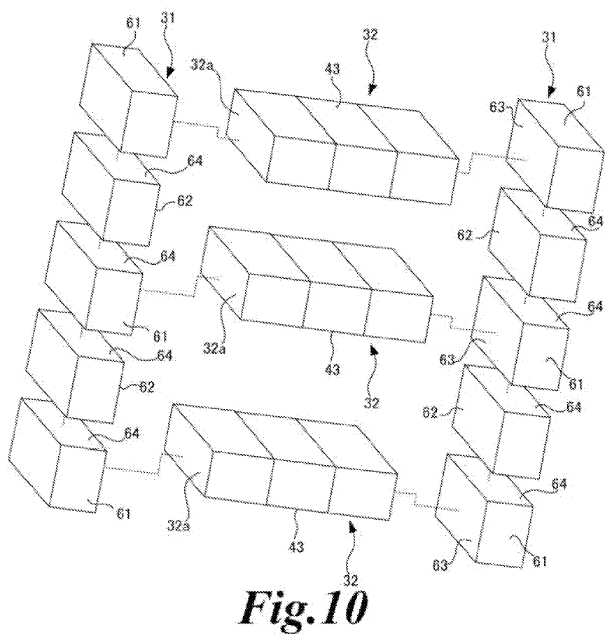

FIG. 10 is the schematic diagram showing the mold core 2 included in the reactor 1 of a second embodiment. As shown in FIG. 10, the mold core 2 may have three leg portions 32. The coil is attached to at least one of the three leg portions 32. In the mold core 2 having the three leg portions 32, the yoke cores 41 are divided into, for example, five core blocks 5. The five core blocks 5 are individually manufactured through the dust core forming step, the mold setting step, and the resin injecting step. The five core blocks 5 become three leg-portion-side blocks 61 and two connecting blocks 62.

The leg-portion-side blocks 61 are arranged on both outer sides, the leg-portion-side blocks 61 and the connecting blocks 62 are alternately arranged, and the core blocks 5 are arranged in a row. The inter-block connecting surfaces 64 are connected with each other without gaps. Leg portion connecting surfaces 63 are arranged on each of the three leg-portion-side blocks 61, and the three leg portion connecting surfaces 63 are aligned with the same reference plane Ss by the support portions Ms of the fixed mold (lower mold) Mfd, and fixed with yoke resins 42. The gate Mg is arranged so as to avoid the leg-portion-side blocks 61 and face one or both of the two connecting blocks 62.

Furthermore, the mold core 2 includes, for example, four or more leg portions 32, the yoke portions 31 includes the same number of leg-portion-side blocks 61 as the leg portions 32, and the connecting blocks 62 one less than the leg portions 32, the leg-portion-side blocks 61 and the connecting blocks 62 may be alternately arranged one by one after arranging the leg-portion-side blocks 61 on both outer sides.

### Third Embodiment

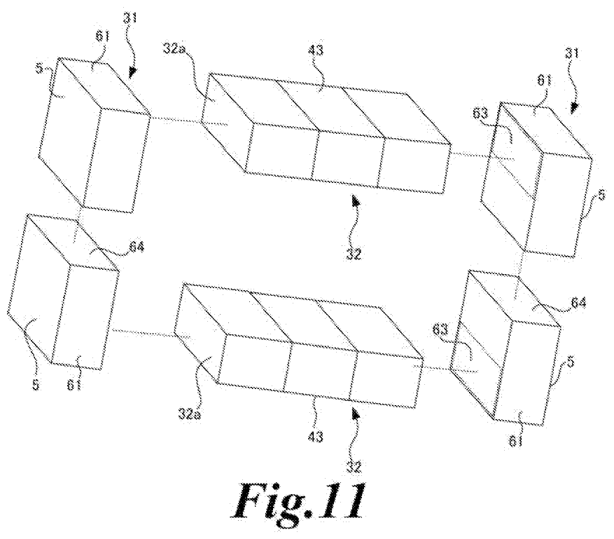

FIG. 11 is the schematic diagram showing the mold core 2 included in the reactor 1 of a third embodiment. When one leg-portion-side block 61 is provided for one leg 32, and one leg portion connecting surface 63 is provided for each leg-portion-side block 61, each leg portion side block 61 can be independently positioned on the reference plane Ss.

Therefore, the yoke cores 41 have leg-portion-side blocks 61 that match the number of leg portions 32, and the inter-block connecting surfaces 64 of the leg-portion-side blocks 61 may be directly connected to each other without the connecting blocks 62 therebetween.

### Effect

As described above, the mold core 2 of the reactor 1 of each embodiment is made of a dust core and includes the yoke cores 41 for connecting a plurality of leg portions 32, and the yoke resins 42 for molding the yoke cores 41 by insert molding. The yoke cores 41 are divided into a plurality of core blocks 5 connected in a row without gaps, and the core blocks 5 include leg-portion-side blocks 61 that are connected to the leg portions 32 one-to-one.

When the dust core is pressure-molded and annealed, various parts of the molded body are deformed by shrinkage, warpage, and the like. Variation in deformation at various parts becomes more significant as the size of the molded body to be pressure-molded and annealed increases. On the other hand, in this mold core 2, the yoke cores 41 are divided into a plurality of the core blocks 5. In the core blocks 5, variations in deformation at various parts are reduced as compared with the case when pressure molding and annealing the entire yoke core 41 as one molding.

Therefore, in this mold core 2, the leg portion connecting surfaces 63 of the leg-portion-side blocks 61 are easily aligned on the same plane, and a gap is less likely to occur between the leg portion end surfaces 32a of the leg portions 32 and the leg portion connecting surfaces 63. In addition, the magnetic resistance can be easily approximated to the design, and the deterioration of the DC superimposition characteristics of the inductance can be suppressed.

Moreover, this mold core 2 can employ the following manufacturing method. That is, the method of manufacturing the mold core 2 includes a dust core forming step, a mold setting step, and an injection molding step. In the dust core forming step, the dust core is formed to be the yoke cores 41 for connecting the plurality of leg portions 32. The yoke core 41 is divided into a plurality of core blocks 5 connected in a row without gaps, and the core blocks 5 are individually formed by pressure molding and annealing in the dust core forming step.

Then, in the mold setting step, the yoke cores 41 is installed on the fixed mold (lower mold) Mfd, and the yoke cores 41 are set in the mold by pressing the yoke cores 41 against the fixed mold (lower mold) Mfd with the slide mold Ma. At this time, in the mold setting step, the leg portion connecting surfaces 63 of the leg-portion-side blocks 61 are placed on each support portion Ms of the fixed mold (lower mold) Mfd and the core blocks 5 are arranged side by side on a fixed mold (lower mold) Mfd. The leg-portion-side blocks 61 are pressed against the support portions Ms by the slide mold Ma and the leg portion connecting surfaces 63 are positioned so as to be aligned with the reference plane Ss which is the same plane.

Finally, after this mold setting step, in the injection molding step, the yoke cores 41 are molded with the yoke resins 42 by injecting resin into the mold. As a result, each of the leg-portion-side blocks 61 includes leg portion connecting surface 63 that connects with the leg portion end surface 32a of the corresponding leg portion 32 and is covered with the yoke resin 42 while the leg portion connecting surfaces 63 are positioned so as to be aligned on a same plane. Therefore, the leg portion connecting surfaces 63 of the leg-portion-side blocks 61 are aligned on the same plane, and a gap is more unlikely to occur between the leg portion end surfaces 32a of the leg portions 32 and the leg portion connecting surfaces 63. In addition, the magnetic resistance can be more easily approximated to the design, and the deterioration of the DC superimposition characteristics of the inductance can be further suppressed.

In this mold core 2, it is sufficient that the leg-portion-side blocks 61 can be moved independently, so that the leg portion connecting surfaces 63 can be positioned so as to be aligned on the same plane, so instead of using this manufacturing method, for example, the entire yoke core 41 may be pressure-molded and annealed, and then cut into a plurality of core blocks 5. However, by performing pressure molding and annealing for each core block 5, the effect of reducing the local deformation amount is also imparted.

Also, the yoke resins 42 include the leg-portion-side openings 71 through which the leg portion connecting surfaces 63 are exposed and the rear openings 72 located on the opposite side of the leg-portion-side openings 71. Heat of the yoke portions 31 can be dissipated from these rear openings 72. Further, the yoke cores 41 can be pushed into the leg portions 32 using the rear opening 72 when the leg portions 32 and the yoke portions 31 are adhered to each other, thus adhesive pressure can be increased, and the room for gaps can be reduced.

Further, the core blocks 5 may include the connecting blocks 62 interposed between the leg-portion-side blocks 61, and the yoke resins 42 are injected toward the connecting blocks 62 in the injection molding step. As a result, in the yoke resins 42, the gate mark bulging portions 74, which are the resin injection hole mark, are formed on the connecting block covering area 75 covering the connecting block 62.

As a result, the injection pressures received by the leg-portion-side blocks 61 are reduced, the position of the leg portion connecting surfaces 63 are less likely to shift, and the position of the leg portion connecting surface 63 aligned with the reference plane Ss can be easily maintained. It should be noted that the row of the core blocks 5 may be strongly gripped by the mold to maintain the position of the leg portion connecting surfaces 63 aligned with the reference plane Ss.

In addition, the yoke resins 42 includes the fastening portions 81 that are fastened to the leg portions 32 by tightening fasteners such as bolts and screws, the fastening portions 81 are formed in the covering area that covers the leg-portion-side blocks 61. This can prevent the yoke portions 31 and the leg portions 32 from being separated due to deterioration of the adhesive.

Here, the fastening portions 81 generates torque when the fasteners are tightened, and are likely to break the adhesive layer between the leg portion connecting surfaces 63 and the leg portion end surfaces 32a. However, since the leg portion connecting surfaces 63 are aligned with the reference plane Ss and the leg portion connecting surfaces 63 and the leg portion end surfaces 32a are joined with high precision over the entire area, the adhesive layer can sufficiently withstand the torque. Therefore, it is easy to form the fastening portions 81 in the covering area that covers the leg-portion-side blocks 61.

The above embodiments of the present application are presented as examples, and are not limited to the above embodiments. The above-described embodiments may be implemented by other various forms, and various omissions, replacements, and changes may be made without departing from the scope of claims. The embodiments and modifications thereof are included in the scope of the present application.

### REFERENCE SIGN

1: reactor
2: mold core
31: yoke portion
32: leg portion
32: leg portion end surface
41: yoke core
42: yoke resin
43: leg core
5: core block
61: leg-portion-side block
62: connecting block
63: leg portion connecting surface
64: inter-block connecting surface
71: leg-portion-side opening
72: rear opening
73: holding opening
74: gate mark bulging portion
75: connecting block covering area
81: fastening portion
82: fastening portion
83: stay
9: core block
Ma: slide mold
Mg: gate
Mfd: fixed mold (lower mold)
Mfd: fixed mold (upper mold)
Ms: support portion
Msc: projecting portion
Ss: reference plane

What is claimed is:

1. A mold core comprising:
a yoke core made of a dust core and connecting a plurality of leg portions; and
a yoke resin molding the yoke core by insert molding,
wherein the yoke core is divided into a plurality of core blocks connected in a row without gaps; and
the core blocks include leg-portion-side blocks that are connected to the leg portions one-to-one.

2. The mold core according to claim 1, wherein
each of the leg-portion-side blocks include a leg portion connecting surface connecting with an end surface of a corresponding leg portion and is covered with the yoke resin while the leg portion connecting surfaces are positioned so as to be aligned on a same plane.

3. The mold core according to claim 2, wherein the yoke resin comprising:
a leg-portion-side opening through which the leg portion connecting surface is exposed; and
a rear opening located on an opposite side of the leg-portion-side opening.

4. The mold core according to claim 1, wherein:
the core blocks include a connecting block interposed between the leg-portion-side blocks;
the yoke resin has a gate mark bulging portion that is a resin injection hole mark; and
the gate mark bulging portion is formed in a covering region covering the connecting block.

5. The mold core according to claim 2, wherein:
the core blocks include a connecting block interposed between the leg-portion-side blocks;
the yoke resin has a gate mark bulging portion that is a resin injection hole mark; and
the gate mark bulging portion is formed in a covering region covering the connecting block.

6. The mold core according to claim 1, wherein:
the yoke core is divided into three core blocks; and
the core blocks include two leg-portion-side blocks and a connecting block interposed between the leg-portion-side blocks.

7. The mold core according to claim 1, wherein:
the yoke core is divided into five core blocks; and
the core blocks include three leg-portion-side blocks and two connecting blocks interposed between two of the leg-portion-side blocks.

8. The mold core according to claim 4, wherein:
the yoke core is divided into five core blocks;
the core blocks include three leg-portion-side blocks and two connecting blocks interposed between two of the leg-portion-side blocks; and
the gate mark bulging portion is formed in the covering region covering at least one of the connecting blocks.

9. The mold core according to claim 5, wherein:
the yoke core is divided into five core blocks;
the core blocks include three leg-portion-side blocks and two connecting blocks interposed between two of the leg-portion-side blocks; and
the gate mark bulging portion is formed in the covering region covering at least one of the connecting blocks.

10. The mold core according to claim 1, wherein the leg portion is further included.

11. The mold core according to claim 10, wherein:
the yoke resin includes a fastening portion that is fastened to the leg portion by tightening fastener; and
the fastening portion is formed in a covering area that covers the leg-portion-side blocks.

12. A reactor comprising:
the mold core according to claim 10; and
a coil attached to at least one leg portions.

13. A method for manufacturing a mold core, comprising:
a dust core forming step forming a dust core serving as a yoke core for connecting a plurality of leg portions;
a mold setting step setting the yoke core in a mold by installing the yoke core in a fixed mold of the mold and pressing the yoke core against the fixed mold with a slide mold of the mold; and
an injection molding step molding the yoke core with a yoke resin by injecting resin into the mold,
wherein:
the yoke core is divided into a plurality of core blocks connected in a row without gaps and the core blocks includes leg-portion-side blocks that are connected to the leg portions one-on-one;
each of the leg-portion-side blocks has a leg portion connecting surface that connects with an end surface of a corresponding leg portion;
in the dust core forming step, the core blocks are individually formed by pressure molding and annealing;
the fixed mold has support portions that are positioned at a same height and support each of the leg portion connecting surfaces, and
wherein;
in the mold setting step, the core blocks are arranged side by side in the fixed mold while the leg portion connecting surface of the leg-portion-side block is placed on each support portion; and
the leg portion connecting surfaces are positioned so as to be aligned on a same plane by pressing the leg-portion-side blocks against each of the support portions with the slide mold.

14. The method for manufacturing a mold core according to claim 13, wherein, in the dust core forming step, the dust core is formed for each core block.

15. The method for manufacturing a mold core according to claim 13; wherein:
the core blocks include a connecting block interposed between the leg-portion-side blocks; and
the yoke resin is injected toward the connecting block in the injection molding step.

16. The method for manufacturing a mold core according to any one of claim 13, further comprising a connecting step adhering the leg portion to the leg portion connecting surface with an adhesive.

17. The method for manufacturing a mold core according to any one of claim 13;
wherein in the injection molding step, the resin is formed with a fastening portion that is fastened to the leg portion by tightening a fastener; and
further comprising a connecting step of connecting the leg portion to the yoke core molded with the resin through the fastening portion.
